(19) United States
(12) Patent Application Publication
(10) Pub. No.: US 2002/0013787 A1
(43) Pub. Date: Jan. 31, 2002

(54) Automated sample tracking and generation of corresponding prescription

(76) Inventors: Daniel Lyon Pollard, Durham, NC (US); Craig Francis Donatucci, Durham, NC (US); Lloyd Albert Hey, Durham, NC (US); Peter Franklin Herbert JR., Durham, NC (US)

Correspondence Address: DANIELS & DANIELS, P.A., SUITE 200, GENERATION PLAZA, 1822 N.C. HIGHWAY 54, EAST, DURHAM, NC, 27713, US

(21) Appl. No.: 09/827,812

(22) Filed: Apr. 6, 2001

Related U.S. Application Data
(60) Provisional application No. 60/195,889, filed on Apr. 7, 2000.

(51) Int. Cl. G06F 17/60

(52) U.S. Cl. 707/507

(57) ABSTRACT

A method for reading information about a specific sample of a particular product or a health care service into a medical information manager system. In a preferred embodiment, information about a specific sample of a medication is used as: 1) part of product sample tracking; 2) included in the health care records for the particular patient receiving the specific sample; and to 3) partially populate a prescription for additional quantities of the particular product provided in the specific sample.

### PRIORITY

This application claims priority from a United States provisional application Ser. No. 60/195,889 with filing date Apr. 7, 2000.

### BACKGROUND

This invention is useful in the field of medical information management.

Assignee of this invention provides healthcare institutions with physician designated point-of-care solutions that improve information flow, quality of patient care, and improve cash flow for the healthcare institutions. The emphasis is balancing the time available by a physician to gather information to the need to have clinical information. Thus, there is a general goal to simplify and minimize the input by the healthcare provider to collect only the most critical charge capture and documentation elements necessary to provide patient care and to document the visit for billing purposes.

One part of the system is implemented on a personal digital assistant (PDA) carried by the physician or other health care provider. The health care provider enters diagnostic and procedural information as the provider moves from patient to patient. The information entered into the PDA is then communicated to other portions of the system.

Against this backdrop of seeking to record only the critical information for a provider/patient encounter. It was recognized that current medical information management systems including systems designed by assignee are not set up to capture information regarding “samples” of pharmaceuticals and related disposable equipment.

Frequently a visit to a doctor's office will result in a doctor suggesting that the patient try a sample of a given drug or disposable product. Sometimes the doctor provides several samples sometimes just one sample sized package. Along with the sample, the doctor will often write a prescription for the same drug or product. If the patient finds the sample to be helpful and without serious side effects the patient can proceed to fill the prescription.

In an institutional setting where drug interactions need to be accounted for or where more than one doctor may be treating a patient, it may be useful to record the specific drug, and dosing regime provided to a patient so that others may have access to this information.

Tracking the distribution of these “free samples” provides a mechanism to recall defective samples and also helps maintain accountability for the inventory of samples.

It is an object of the invention to provide a method to capture information regarding a specific sample issued to a particular patient into a medical information management system.

It is a further object of this invention to provide a method of capturing information regarding the specific sample in a way that does not unduly burden the busy healthcare provider.

It is yet a further object of this invention to use the captured information to partially populate an electronic form for a prescription for the particular patient for a particular product of the type provided with the specific sample.

### BRIEF SUMMARY OF DISCLOSURE

The method of the present invention calls for acquiring data from a physical medication sample and integrating this data with patient information to generate a prescription and provide for accountability for the inventory of samples. The data can be acquired through a variety of means such as barcode scanning, reading magnetic strip, radio frequency broadcast, infra red transmission, or optical character recognition.

One embodiment of the present invention calls for creating a prescription for a medication (or any other type of order) and tracking the samples given to a patient by scanning barcoded information that is present on the sample. The barcoded information could be present in the container which holds packages of medication samples, on the exterior packaging of the medication sample, on an insert in the package, on the container which holds the medication or even on the medication itself.

This concept of inputting information by a reader associated with the medical information management system can be extended beyond medication orders and medication samples to the full variety of medical orders. In addition to medication orders, other orders can be created for laboratory tests, radiology tests, consults, medical procedures (as defined by a HCPCS or CPT code), follow-up appointments or exercise programs. These orders could be initiated by acquiring data from an object that represents the particular type of order. For example, a barcoded encounter sheet could provide the data to initiate the order.

It is an object of the invention to provide a method to capture information regarding a specific sample issued to a particular patient into a medical information management system.

It is a further object of this invention to provide a method of capturing information regarding the specific sample in a way that does not unduly burden the busy healthcare provider.

It is yet a further object of this invention to use the captured information to partially populate an electronic form for a prescription for the particular patient for a particular product of the type provided with the specific sample.

These and other advantages of the present invention are apparent from the detailed description that follows.

### BRIEF DESCRIPTION OF THE DRAWINGS

FIG. 1 is a barcode for a sample of a drug in accordance with one embodiment of the present invention.

FIG. 2 is a flowchart of the use of one embodiment of the method of the present invention.

FIG. 3 is a screen display of a medical information manager device showing a selection of a particular patient under one embodiment of the present invention.

FIG. 4 is a screen display of a medical information manager device showing the display of some machine-readable information under one embodiment of the present invention.

FIG. 5 is a screen display of a medical information manager device showing a partially populated prescription form for the particular product provided as a sample to the particular patient under one embodiment of the present invention.

### DETAILED DESCRIPTION OF THE DISCLOSED EMBODIMENT

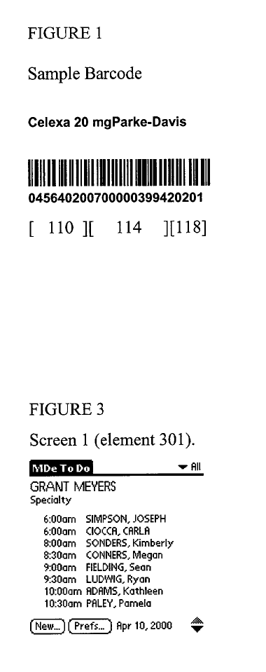

FIG. 1 illustrates a bar code such as can be used by the present invention. The invention reads machine readable information such as barcodes. The machine readable information would be provided by the manufacturers. The information could include: 1) a Standard identification code for the drug, likely the NDC number. (Such standard information can represent Name of Manufacturer, Name of Drug, Strength/formulation of drug, and drug Dose); 2) Lot number and 3) Expiration date.

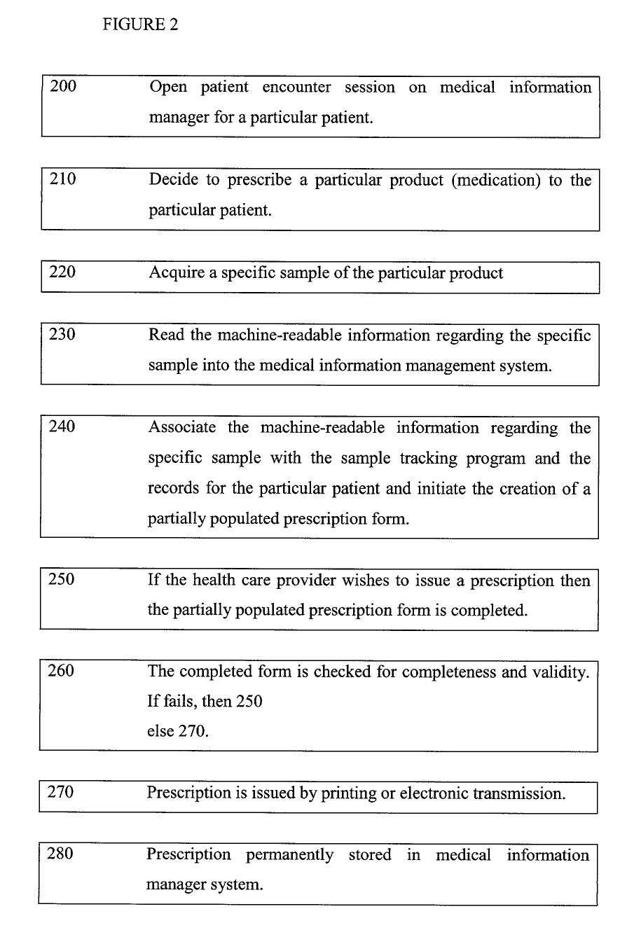

Moving now to the flowchart in FIG. 2, a physician is using a medical information manager such as the MDeverywhere system.

In step 200 the physician opens a patient encounter by choosing a patient. One way of selecting a patient is done by selecting a patient identified on the screen showing the physicians schedule of patients to be seen. (see screen 1 in FIG. 3)

Step 210 the physician interacts with the patient and or medical records. In some situations, the physician decides to provide a sample of a given product to the patient.

Step 220 physician accesses a sample of the medication present in the physician's medical office to give to the patient for the patient to use until the patient can fill the prescription. For some physicians outside of a hospital environment, there would be little more to do beyond giving the sample and instructions to the patient. However, a physician operating within a hospital or affiliated clinic is under additional constraints because regulations exist for hospitals that require the tracking of medication samples given to patients. The tracking requirement covers not only the product identification code for the particular product, but also the lot number and expiration date for the specific sample within the set of samples for that particular product.

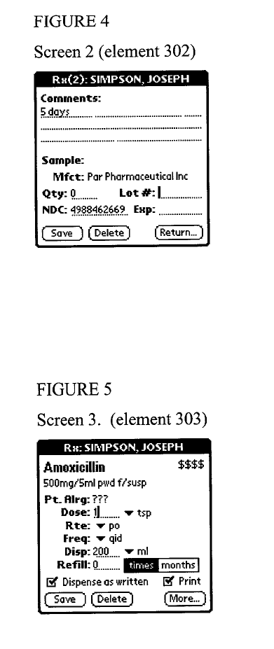

Step 230 the physician acquires sample information in a machine readable form. In this case by using a barcode scanning device to scan the information about the sample. The act of scanning the sample, triggers several actions. The barcode information is passed to the medical information manager. One screen layout for the scanned information is shown in screen 2 (element 302) in FIG. 4. FIG. 4 shows Screen 2 partially filled out so as to highlight the time necessary for a physician to manually enter the information into the three fields.

One preferred embodiment for coding the needed information into a barcode is shown in FIG. 1. In barcode 100, the first field 110 is the first ten bar code characters. First field 110 contains a standard identification code for the drug, likely the NDC number.

In this embodiment, the second field 114 is eight or ten characters long and contains the lot number for the sample. In this embodiment, the third field 118 contains a four character representation of the expiration date for the sample.

Step 240. After the sample is scanned, the sample information is recorded (what particular product, lot number, and expiration date). The sample information is added to the records for the particular patient. In the preferred embodiment, the system also initiates the creation of a prescription for the medication that was given as a sample.

Step 250. If the physician wishes to prescribe additional medication matching the sample at this time then the physician can complete the prescription. One embodiment of a screen for working on this process is shown in Screen 303 in FIG. 5.

Step 260. After the physician completes the prescription, rules operating on the medical information manager check for the completeness and validity of the prescription.

Step 270. After passing through the completeness and validity check, the prescription can then be printed or electronically transmitted.

Step 280. Once a request has been made to print or electronically transmit a prescription, then the prescription is permanently stored in the medical information manager system.

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method for inclusion of information regarding medical samples into a medical information manager system, the method comprising:
A) Initiating an electronic session on a medical information manager device associated with the medical information manager system regarding an interaction between a health care provider and a particular patient;
B) Use an input device associated with the medical information manager system to read into the medical information manager device the machine-readable attributes of a specific sample of a particular product to be provided to the patient;
C) Associate the machine readable attributes of the specific sample with a set of the particular patient's health records stored in the medical information manager system, the machine-readable attributes including a standard identification code for a particular product corresponding to the specific sample;
D) Use the machine-readable attributes of the specific sample to partially populate an electronic prescription form for the particular product matching the specific sample; and
E) receive input through an input device connected to the medical information manager device from the health care provider to complete the partially populated prescription form.

2. The method of claim 1 wherein the machine-readable attributes of a specific sample include a lot number for the specific sample and wherein a record of the provision of this specific sample is stored for use in a program for tracking of samples.

3. The method of claim 1 further wherein the machine-readable attributes of a specific sample are read by reading a communication media selected from the group consisting of barcodes, magnetic strips, radio frequency broadcast, infra red transmission, and characters suitable for optical character recognition.

4. The method of claim 1 further wherein the machine-readable attributes of a specific sample are read by reading a machine-readable media on the container which holds packages of the specific samples.

5. The method of claim 1 further wherein the machine-readable attributes of a specific sample are read by reading a machine-readable media on the exterior packaging of the specific sample.

6. The method of claim 1 further wherein the machine-readable attributes of a specific sample are read by reading a barcode on the particular product in the specific sample.

7. The method of claim 1 wherein the health care provider inputs by reader associated with the medical information manger system a code indicating that the particular patient is to receive a medical order for medical services selected from the group consisting of laboratory tests, radiology tests, consults, medical procedures, follow-up appointments, and exercise programs.
